(19) United States
(12) Patent Application Publication
(10) Pub. No.: US 2021/0181407 A1
(43) Pub. Date: Jun. 17, 2021

(54) Optical Device and Optical Coupling Method

(71) Applicant: Nippon Telegraph and Telephone Corporation, Tokyo (JP)

(72) Inventors: Koji Takeda, Tokyo (JP); Yuta Ueda, Tokyo (JP); Hiroyuki Ishii, Tokyo (JP); Takushi Kazama, Tokyo (JP); Hitoshi Wakita, Tokyo (JP)

(21) Appl. No.: 17/053,262

(22) PCT Filed: Apr. 22, 2019
(86) PCT No.: PCT/JP2019/016944

§ 371 Date: Nov. 5, 2020

(30) Foreign Application Priority Data
May 9, 2018 (JP) 2018-090419

(51) Int. Cl. G02B 6/028; G02B 6/42; G02B 6/122; G02B 6/30

(52) U.S. Cl. CPC G02B 6/028; G02B 6/30; G02B 6/1225; G02B 6/42

(57) ABSTRACT

An optical device includes a waveguide configured with a waveguide core and clad layers. A thickness of the upper clad layer between a surface of a coupling unit of the waveguide and the waveguide core is set to a thickness with which optical evanescent coupling is capable of being performed with a waveguide or optical fiber for monitoring in a case where the waveguide or optical fiber for monitoring is arranged in a vicinity of the surface of the coupling unit.

### CROSS-REFERENCE TO RELATED APPLICATIONS

This application is a national phase entry of PCT Application No. PCT/JP2019/016944, filed on Apr. 22, 2019, which claims priority to Japanese Application No. 2018-090419, filed on May 9, 2018, which applications are hereby incorporated herein by reference.

### TECHNICAL FIELD

The present invention relates to an optical coupling form of an optical device.

### BACKGROUND

On board optics (OBO) are a form in which a component group is directly attached to a printed substrate or board in a communication apparatus without packaging an optical transceiver. In the OBO, wafer level packaging (WLP) is often used which packages optical components at a chip level. However, because a packaging process is performed prior to formation of a chip, it is difficult to perform an examination prior to packaging of an element extracting light from an element end surface in a wafer state. Thus, it is necessary to obtain optical coupling in the wafer state and in a detachable form with respect to an optical device.

A waveguide type optical device in related art has used a grating coupler (GC) (see Non-Patent Literature 1) or a jump mirror (45° mirror) having an angle of approximately 45° (see Non-Patent Literature 2) when an attempt is made to examine optical input and output in the wafer state.

However, there has been a problem that as represented by a Si waveguide, the GC may be used only in a case where the refractive indices of a waveguide core and a clad are plural times different.

Further, there has been a problem that the 45° mirror bents the optical path of an output of the waveguide at 90° and may thus not be applied to the waveguide actually used for operation.

### CITATION LIST

### Non-Patent Literature

Non-Patent Literature 1: Frederik Van Laere et al., “Compact Focusing Grating Couplers for Silicon-on-Insulator Integrated Circuits”, IEEE Photonics Technology Letters, Vol. 19, No. 23, pp. 1919-1921, 2007.
Non-Patent Literature 2: W.-J. Lee et al., “Surface Input/Output Optical Splitter Film for Multilayer Optical Circuits”, IEEE Photonics Technology Letters, Vol. 24, No. 6, pp. 2012-2014, 2012.

### SUMMARY

### Technical Problem

Embodiments of the present invention have been made to solve the above problem, and an object thereof is to provide an optical device that may easily obtain optical coupling in a wafer state and in a detachable form.

### Means for Solving the Problem

An optical device of embodiments of the present invention includes a first waveguide configured with a core guiding light and a clad surrounding the core, in which a thickness of the clad between a surface of a coupling unit of the first waveguide and the core is a thickness with which optical evanescent coupling is capable of being performed with a second waveguide or an optical fiber for monitoring in a case where the second waveguide or the optical fiber for monitoring is arranged in a vicinity of the surface of the coupling unit.

Further, in one configuration example of the optical device of embodiments of the present invention, the thickness of the clad of the first waveguide gradually becomes thinner from a region other than the coupling unit toward the coupling unit.

Further, in one configuration example of the optical device of embodiments of the present invention, a width of a core in a direction perpendicular to an optical propagation direction of the first waveguide in the coupling unit is narrower than a width of a core in a region other than the coupling unit.

Further, in one configuration example of the optical device of embodiments of the present invention, the coupling unit is provided in a region of the first waveguide connecting integrated circuit configuration components of the optical device or in a region of the first waveguide through which light is input to and output from the integrated circuit configuration components of the optical device.

Further, in one configuration example of the optical device of embodiments of the present invention, the integrated circuit configuration components include a laser and an optical modulator modulating light from the laser, and the coupling unit is provided in a region of the first waveguide connecting the laser with the optical modulator and in a region of the first waveguide outputting light from the optical modulator.

Further, in one configuration example of the optical device of embodiments of the present invention, the integrated circuit configuration components include a laser, a 90° hybrid coupler mixing main signal light with local light from the laser, and a photodiode receiving output light from the 90° hybrid coupler, and the coupling unit is provided in a region of the first waveguide inputting the main signal light to the 90° hybrid coupler, a region of the first waveguide connecting the laser with the 90° hybrid coupler, and a region of the first waveguide connecting the 90° hybrid coupler with the photodiode.

An optical coupling method of an optical device of embodiments of the present invention includes arranging a second waveguide or an optical fiber for monitoring configured with a second core and a second clad surrounding the second core in a vicinity of a surface of a coupling unit of a first waveguide with respect to the optical device including the first waveguide configured with a first core and a first clad surrounding the first core, in which a thickness of the first clad between the surface of the coupling unit of the first waveguide and the first core is a thickness with which optical evanescent coupling is capable of being performed with the second waveguide or the optical fiber for monitoring, and a thickness of the second clad facing the surface of the coupling unit and provided between a surface of the second waveguide or the optical fiber for monitoring and the second core is a thickness with which optical evanescent coupling is capable of being performed with the first waveguide.

Further, in one configuration example of the optical coupling method of an optical device of embodiments of the present invention, the first waveguide is a compound semiconductor waveguide in which the first core and the first clad are formed of a compound semiconductor, and the second waveguide for monitoring arranged in the vicinity of the surface of the coupling unit of the first waveguide is a semiconductor waveguide in which at least a second core is formed of a semiconductor.

### Effects of Embodiments of the Invention

In embodiments of the present invention, the thickness of a clad between a surface of a coupling unit of a first waveguide of an optical device and a core is set to a thickness with which optical evanescent coupling is capable of being performed with a second waveguide or optical fiber for monitoring, and optical coupling with the second waveguide or optical fiber for monitoring may thereby be obtained easily. In embodiments of the present invention, the detachable second waveguide or optical fiber for monitoring may be used, light may be input to or output from the optical device while a wafer state is maintained, and an examination of the optical device at a wafer level may thus be realized easily.

### BRIEF DESCRIPTION OF THE DRAWINGS

FIG. 1 illustrates vertical cross-sectional views and horizontal cross-sectional views for explaining a fabrication method of a coupling unit for monitoring of an optical device according to a first embodiment of the present invention.

FIG. 2 is a cross-sectional view illustrating a state where an optical fiber for monitoring is provided adjacently to an upper surface of the coupling unit of the optical device according to the first embodiment of the present invention.

FIG. 3 is a diagram representing calculation results of an optical coupling constant and a coupling length between the optical device according to the first embodiment of the present invention and the optical fiber for monitoring, the optical coupling constant and the coupling length being calculated while the thickness of a clad is changed.

FIG. 4 is a cross-sectional view illustrating a structure of an optical device according to a second embodiment of the present invention.

FIG. 5 is a cross-sectional view illustrating a structure of an optical device according to a third embodiment of the present invention.

FIG. 6 is a plan view illustrating another structure of the optical device according to the third embodiment of the present invention.

FIG. 7 is a cross-sectional view illustrating a state where an optical fiber for monitoring is provided adjacently to an upper surface of a coupling unit of an optical device according to a fourth embodiment of the present invention.

FIG. 8 is a diagram representing calculation results of the optical coupling constant and the coupling length between the optical device according to the fourth embodiment of the present invention and the optical fiber for monitoring, the optical coupling constant and the coupling length being calculated while the thickness of the clad is changed.

FIG. 9 illustrates cross-sectional views for explaining a fabrication method of a coupling unit of an optical device according to a fifth embodiment of the present invention.

FIG. 10 illustrates cross-sectional views for explaining another fabrication method of the coupling unit of the optical device according to the fifth embodiment of the present invention.

FIG. 11 is a cross-sectional view illustrating a state where a waveguide for monitoring is provided adjacently to an upper surface of a coupling unit of an optical device according to a sixth embodiment of the present invention.

### DETAILED DESCRIPTION OF ILLUSTRATIVE EMBODIMENTS

### Principle of the Invention

To solve the above problem, in embodiments of the present invention, an upper clad of a waveguide of an optical device is partially thinned. The thickness of the upper clad is thinned to the extent that evanescent coupling is capable of being performed with a waveguide or optical fiber for monitoring whose clad is similarly thinned. When the waveguide or optical fiber for monitoring is caused to approach a section in which the upper clad of the waveguide of the optical device is thinned, the section acts as a directional coupler in the perpendicular direction to a wafer. Thus, output light of the waveguide of the optical device may be output to the waveguide or optical fiber for monitoring, or input light from the waveguide or optical fiber for monitoring may be input to the waveguide of the optical device. Further, when the waveguide or optical fiber for monitoring is moved away, the optical device with the thinned upper clad may act as an optical device without any change.

### First Embodiment

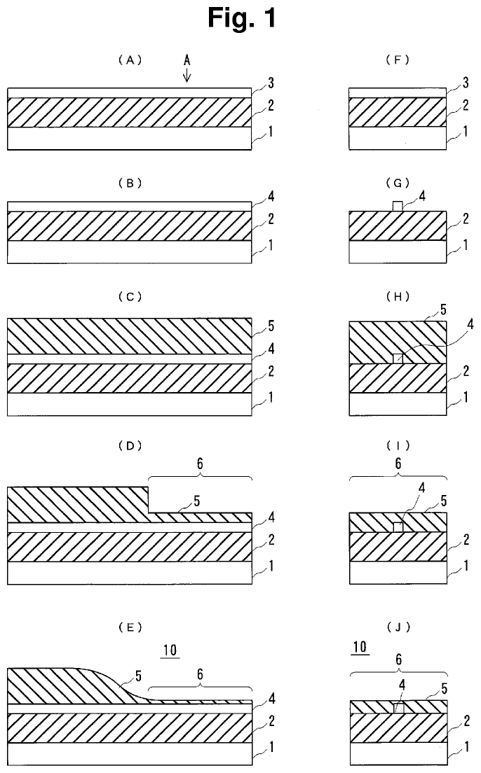

Embodiments of the present invention will hereinafter be described with reference to drawings. FIG. 1(A) to FIG. 1(E) are vertical cross-sectional views for explaining a fabrication method of a coupling unit for monitoring of an optical device according to a first embodiment of the present invention, and FIG. 1(F) to FIG. 1(J) are horizontal cross-sectional views in a case where respective optical devices of FIG. 1(A) to FIG. 1(E) are sectioned in the position of A.

Here, as an example of the optical device, an optical waveguide of a dielectric body will be raised. The fabrication method of the coupling unit for monitoring of the optical device of this embodiment is as follows.

First, as illustrated in FIG. 1(A) and FIG. 1(F), films of a lower clad layer 2 and a core layer 3 are formed on a substrate 1 by a method such as CVD (chemical vapor deposition), sputtering, or evaporation. Then, the core layer 3 is processed by using lithography and etching, and a waveguide core 4 is formed as illustrated in FIG. 1(B) and FIG. 1(G).

Next, as illustrated in FIG. 1(C) and FIG. 1(H), a film of an upper clad layer 5 is formed so as to cover the whole waveguide core 4. Then, as illustrated in FIG. 1(D) and FIG. 1(I), the upper clad layer 5 only in the region of a coupling unit 6 for monitoring is etched. Finally, as illustrated in FIG. 1(E) and FIG. 1(J), the upper clad layer 5 is polished as needed such that the film thickness of the upper clad layer 5 does not steeply change.

In the above method, an optical device 10 in which the upper clad layer 5 of the coupling unit 6 for monitoring becomes thin may be fabricated. A waveguide or optical fiber for monitoring in which a clad layer is thinned similarly is provided adjacently to such a coupling unit 6 from an upper surface, and optical coupling may thereby be obtained between the optical device 10 and the waveguide or optical fiber for monitoring.

The light propagated in the optical device 10 is trapped in the core 4 of a waveguide formed with the lower clad layer 2, the waveguide core 4, and the upper clad layer 5 but may leak into regions of the clad layers 2 and 5. When the film thickness of the upper clad layer 5 sharply changes as illustrated in FIG. 1(D), the light leaking out to the upper clad layer 5 may be scattered and become loss. In addition, this may become a factor of reflection of light in the point that the film thickness of the upper clad layer 5 sharply changes. Accordingly, such scattering or reflection may be inhibited by making a slope of the upper clad layer 5 gentle as illustrated in FIG. 1(E).

In this embodiment, it is assumed that a dielectric optical waveguide is provided which uses partially doped SiO₂, SiOx, or the like as a material of the clad layer. However, this embodiment may be applied to a polymer waveguide using a polymer as a material of the clad layer or a semiconductor waveguide using a semiconductor as a material of the core and the clad layer.

Further, because a power monitor, a laser, a modulator, and so forth described later may be fabricated with compound semiconductors, monolithic integration may be intended when a waveguide of a compound semiconductor is used as a waveguide for coupling.

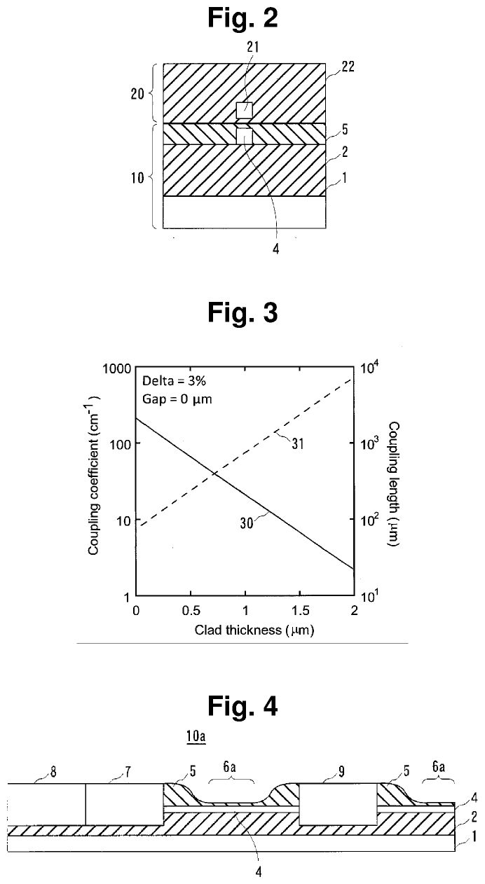

Next, a description will be made about optical mode calculation results for explaining effects of this embodiment. FIG. 2 is a cross-sectional view illustrating a state where an optical fiber 20 for monitoring is provided adjacently to an upper surface of the coupling unit of the optical device 10 of this embodiment. The optical fiber 20 for monitoring is configured with a core 21 and a clad 22. The clad 22 of a surface provided adjacently to the upper surface of the coupling unit of the optical device 10 is processed to be thin to the extent that evanescent coupling is capable of being performed with the optical device 10.

Here, it is presumed that the optical device 10 contacts with the optical fiber 20 for monitoring with no gap. Further, the refractive index of the clad layers 2 and 5 and the clad 22 is presumed to be 1.45, and the refractive index ratio between the core 4 and the clad layers 2 and 5 and the refractive index ratio between the core 21 and the clad 22 are presumed to be 3%. Further, the cross-sectional dimensions of the cores 4 and 21 are set to 3 μm-square.

Under the above conditions, the coupling coefficient and coupling length between the optical device 10 and the optical fiber 20 have been calculated by an optical mode analysis while the respective thicknesses (clad thicknesses) of the thinned upper clad layer 5 of the coupling unit of the optical device 10 and the thinned clad 22 contacting with the upper clad layer 5 are changed, and the calculation results are indicated in FIG. 3. In FIG. 3, a reference numeral 30 denotes the coupling coefficient, and a reference numeral 31 denotes the coupling length. The coupling length is a distance necessary for optical energy to completely move from the optical device 10 to the optical fiber 20 and is a length in the direction perpendicular to the page in the example of FIG. 2.

In FIG. 3, even if the respective thicknesses of the thinned upper clad layer 5 of the coupling unit of the optical device 10 and the thinned clad 22 contacting with the upper clad layer 5 are 1.0 μm, light may be extracted from the optical device 10 when a coupling length of 750 μm is provided. Further, if the respective thicknesses of the upper clad layer 5 and the clad 22 may be thinned to 0.5 μm, light may be extracted from the optical device 10 with a coupling length of 240 μm.

Note that it is matter of course that a waveguide for monitoring in which a clad layer of a surface provided adjacently to the upper surface of the coupling unit of the optical device 10 is processed to be thin may be used instead of the optical fiber 20 for monitoring.

### Second Embodiment

Next, a second embodiment of the present invention will be described. FIG. 4 is a cross-sectional view illustrating a structure of an optical device according to the second embodiment of the present invention, and the same reference numerals are given to the same configurations as FIG. 1. In the first embodiment, it is assumed that one simple waveguide is provided as the optical device 10. An optical device 10a of this embodiment is a transmission-side optical integrated circuit for communication, and a laser 7, a power monitor 8 detecting output of the laser 7, and an optical modulator 9 modulating light from the laser 7 are integrated on the substrate 1.

In this embodiment, coupling units 6a are respectively provided in the region of a waveguide connecting the laser 7 with the optical modulator 9 and in the region of a waveguide connecting the optical modulator 9 with a next-stage element (not illustrated). The upper clad layer 5 of the coupling unit 6a is processed to be thin similarly to the first embodiment to the extent that evanescent coupling is capable of being performed with the optical fiber or waveguide for monitoring, and the light input from the laser 7 to the optical modulator 9 and the light input from the optical modulator 9 to the next-stage element may thereby be measured directly without forming a chip. A coupling method with the optical fiber or waveguide for monitoring is as described in the first embodiment.

### Third Embodiment

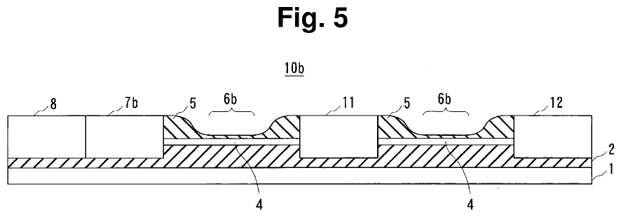

Next, a third embodiment of the present invention will be described. FIG. 5 is a cross-sectional view illustrating a structure of an optical device according to the third embodiment of the present invention, and the same reference numerals are given to the same configurations as FIG. 1. An optical device 10b of this embodiment is a reception-side optical integrated circuit for communication, and a laser 7b for generating local light, the power monitor 8 detecting output of the laser 7b, a 90° hybrid coupler 11 that mixes main signal light with local light from the laser 7b, separates signal light into a quadrature component, and outputs the quadrature component, and a photodiode 12 receiving the output light of the 90° hybrid coupler 11 are integrated on the substrate 1.

In this embodiment, coupling units 6b are respectively provided in the region of a waveguide connecting the laser 7b with the 90° hybrid coupler 11 and in the region of a waveguide connecting the 90° hybrid coupler 11 with the photodiode 12. The upper clad layer 5 of the coupling unit 6b is processed to be thin similarly to the first embodiment to the extent that evanescent coupling is capable of being performed with the optical fiber or waveguide for monitoring, and the light input from the laser 7b to the 90° hybrid coupler 11 and the light input from the 90° hybrid coupler 11 to the photodiode 12 may thereby be measured directly without forming a chip. The coupling method with the optical fiber or waveguide for monitoring is as described in the first embodiment.

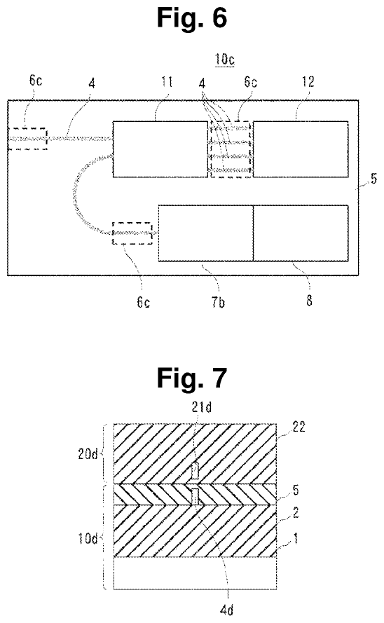

Note that although an input port of the main signal light is omitted in FIG. 5, a plan view of an assumed configuration is illustrated in FIG. 6. In an optical device 10c illustrated in FIG. 6, coupling units 6c are respectively provided in the region of a waveguide inputting the main signal light to the 90° hybrid coupler 11 (an upper left region in FIG. 6), in the region of a waveguide connecting the laser 7b with the 90° hybrid coupler 11, and in the region of a waveguide connecting the 90° hybrid coupler 11 with the photodiode 12, and the upper clad layer 5 of the coupling unit 6c is processed to be thin similarly to the first embodiment.

The coupling units 6c are provided in such regions, and the main signal light input from the outside of the optical device 10c to the 90° hybrid coupler 11, the light input from the laser 7b to the 90° hybrid coupler 11, and the light input from the 90° hybrid coupler 11 to the photodiode 12 may thereby be measured directly without forming a chip.

### Fourth Embodiment

Next, a fourth embodiment of the present invention will be described. FIG. 7 is a cross-sectional view illustrating a state where an optical fiber 20d for monitoring is provided adjacently to an upper surface of a coupling unit of an optical device 10d according to a fourth embodiment of the present invention, and the same reference numerals are given to the same configurations in FIG. 1 and FIG. 2. In the first to third embodiments, it is presumed that the cross-sectional shapes of the waveguide core 4 of the optical devices 10 to 10c and the core 21 of the optical fiber 20 (or waveguide) for monitoring are squares (3 μm-square in the example of FIG. 2). However, optical coupling may be obtained in a wider range by changing the dimensions of the cores.

In this embodiment, the widths of a waveguide core 4d of the optical device 10d and a core 21d of the optical fiber 20d in the perpendicular direction to a light propagation direction (the dimensions in the left-right direction in FIG. 7) are each set to 1 μm, and the heights are set to 3 μm similarly to FIG. 2. Similarly to FIG. 2, it is presumed that the optical device 10d contacts with the optical fiber 20d for monitoring with no gap. Further, the refractive index of the clad layers 2 and 5 and the clad 22 is presumed to be 1.45, and the refractive index ratio between the core 4d and the clad layers 2 and 5 and the refractive index ratio between the core 21d and the clad 22 are presumed to be 3%.

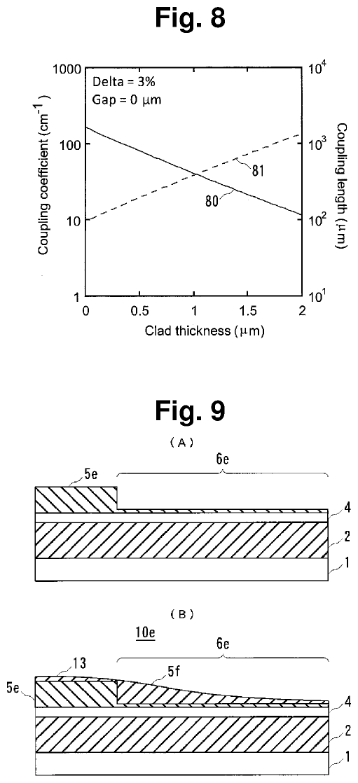

Under the above conditions, the coupling coefficient and the coupling length between the optical device 10d and the optical fiber 20d have been calculated by an optical mode analysis while the respective thicknesses (clad thicknesses) of the thinned upper clad layer 5 of the coupling unit of the optical device 10d and the thinned clad 22 contacting with the upper clad layer 5 are changed, and the calculation results are indicated in FIG. 8. In FIG. 8, a reference numeral 80 denotes the coupling coefficient, and a reference numeral 81 denotes the coupling length. Similarly to the example of FIG. 2, the coupling length is the length in the direction perpendicular to the page in FIG. 8.

It may be understood from FIG. 8 that the coupling constant is large and the coupling length is short even in a case where the thinned upper clad layer 5 of the coupling unit of the optical device 10d and the thinned clad 22 contacting with the upper clad layer 5 become thick compared to the example of FIG. 2.

In a case where a structure as illustrated in FIG. 7 is fabricated, a core is fabricated whose cross-sectional shape is square except the coupling unit, and the width of the core may thereby be narrowed in the coupling unit. For example, in the example of FIG. 6, the waveguide cores 4 are fabricated whose cross-sectional shape is square in the other regions than the coupling units 6c, and the widths of the waveguide cores 4 may thereby be narrowed in three coupling units 6c.

Note that it is matter of course that a waveguide for monitoring in which a clad layer of a surface provided adjacently to the upper surface of the coupling unit of the optical device 10d is processed to be thin may be used instead of the optical fiber 20d for monitoring.

### Fifth Embodiment

Next, a fifth embodiment of the present invention will be described. FIG. 9(A) and FIG. 9(B) are cross-sectional views illustrating a fabrication method of a coupling unit of an optical device according to the fifth embodiment of the present invention, and the same reference numerals are given to the same configurations as FIG. 1. In the first embodiment, a polymer waveguide is mentioned which uses a polymer (resin) as a material of a clad layer. In an optical device 10e of this embodiment, a lower clad layer and an upper clad layer are formed of a resin.

A description will be made in the following about advantages in a case where an upper clad layer 5e is formed of a resin compared to other clad materials. For example, in a case where SiO₂ is used as the upper clad layer 5, a polishing process for smoothly changing the thickness of the upper clad layer 5 as illustrated in FIG. 1(E) is necessary.

Differently, in this embodiment, the upper clad layer 5e formed of a resin is etched only in the region of a coupling unit 6e as illustrated in FIG. 9(A), and a resin 13 is thereafter coated onto the upper clad layer 5e so as to cover that by a procedure such as spin coating. Because the resin 13 itself has a function of flattening a stepped structure, an upper clad layer 5f with no sharp step may be obtained without performing the polishing process (FIG. 9(B)). The resin 13 used here may be any material having a smaller refractive index than the waveguide core 4 and being capable of forming a film by coating.

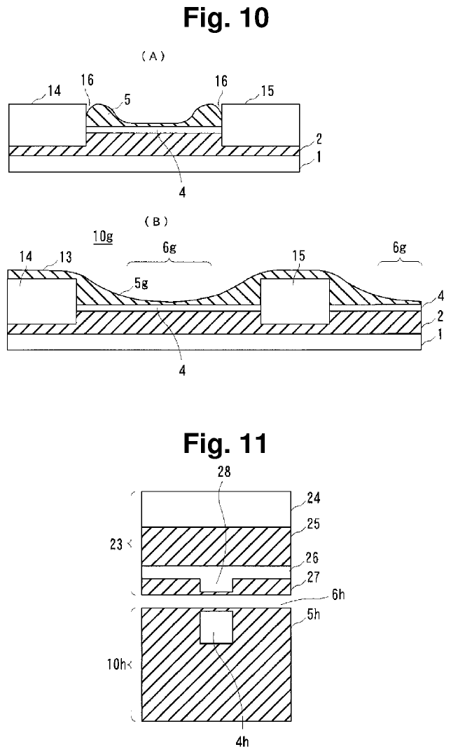

Another advantage by using a resin as the clad material will be described by using FIG. 10(A) and FIG. 10(B). Here, it is assumed that a configuration is provided in which plural function elements are connected as in FIG. 4 or FIG. 5. In order to form the upper clad layer whose thickness smoothly changes in the configuration in FIG. 4 or FIG. 5, in a case where the material of the upper clad layer is a hard substance such as SiO₂, either one of methods is possible between: (I) a method in which integrated circuit configuration components, for example, such as a laser, a modulator, and a photodiode are mounted and a film of the upper clad layer is thereafter formed and polished; and (II) a method in which integrated circuit configuration components are mounted on a waveguide having the upper clad layer which is in advance polished and whose thickness smoothly changes.

Although realization is possible by either method, because upper surfaces of the integrated circuit configuration components are polished in a case of the method of (I), an unnecessary pressure, a peeling stress, and so forth are exerted on the components, and there is a concern about degradation of the components. Although degradation factors about the integrated circuit configuration components are considered to be few in a case of the method of (II), there is a concern that as illustrated in FIG. 10(A), abrasions 16 occur to the upper clad layer 5 in end portions on which integrated circuit configuration components 14 and 15 are mounted due to characteristics of polishing for smoothing an upper surface of the upper clad layer.

On the other hand, the above two concerns may be avoided by using a material capable of being coated such as a resin. As illustrated in FIG. 10(B), in an optical device 10g of this embodiment, the integrated circuit configuration components 14 and 15 are mounted on a waveguide in which the upper clad layer is not present or is in a very thin state. Subsequently, the resin 13 is coated onto the lower clad layer 2, the waveguide core 4, and the integrated circuit configuration components 14 and 15 so as to cover those by a procedure such as spin coating.

In such a manner, in this embodiment, an upper clad layer 5g may automatically be obtained in which a sharp step is not present and the thickness smoothly changes and which becomes thin to the extent that evanescent coupling is capable of being performed with an optical fiber or waveguide for monitoring in a coupling unit 6g. This embodiment has an advantage of enabling avoidance of occurrence of a stress on the integrated circuit configuration components 14 and 15 due to polishing and avoidance of abrasions of the upper clad layer Sg in boundary portions between the waveguide and the integrated circuit configuration components 14 and 15.

### Sixth Embodiment

Next, a sixth embodiment of the present invention will be described. FIG. 11 is a cross-sectional view illustrating a state where a waveguide 23 for monitoring is provided adjacently to an upper surface of a coupling unit of an optical device 10h according to the sixth embodiment of the present invention, and the same reference numerals are given to the same configurations in FIG. 1 and FIG. 2. The optical device 10h of this embodiment is a compound semiconductor waveguide including a waveguide core 4h formed of a compound semiconductor and a clad layer 5h formed of the compound semiconductor.

Also in the compound semiconductor waveguide, it is possible to partially thin the clad layer 5h of a coupling unit 6h (an upper surface in the example of FIG. 11) by etching or the like. However, in order to couple light with an optical fiber or waveguide for monitoring provided adjacently from a substrate upper surface direction as in embodiments of the present invention, the light propagation constants (or equivalent refractive indices) of the optical device 10h and the optical fiber or waveguide for monitoring have to be close to each other. There is a problem that because the waveguide configured with a compound semiconductor in general has a higher refractive index than a dielectric body such as glass, it is difficult to obtain coupling of light by an optical fiber or waveguide mainly formed of glass.

Thus, a combination is possible in which the optical fiber or waveguide for monitoring provided adjacently to the coupling unit 6h of the optical device 10h from the upper surface side is also configured with a semiconductor.

The example of FIG. 11 illustrates a case where a rib waveguide using an SOI (silicon on insulator) wafer as the waveguide 23 for monitoring is provided adjacently to the optical device 10h. The waveguide 23 is configured with an Si substrate 24, a clad layer 25 formed of SiO₂, a waveguide layer 26 formed of Si, and a clad layer 27 formed of SiO₂. A reference numeral 28 denotes a core of the rib waveguide. The clad layer 27 of a surface provided adjacently to the coupling unit 6h of the optical device 10h is processed to be thin to the extent that evanescent coupling is capable of being performed with the optical device 10h.

When an Si waveguide is employed as the waveguide 23 for monitoring as described above, the dimensions such as thickness and width are adjusted, substantially the same propagation constant as the compound semiconductor may thereby be obtained, and light may be also extracted from a compound semiconductor having a relatively high refractive index. Because the integrated circuit configuration components such as the power monitor, the laser, and the modulator may be fabricated with compound semiconductors, monolithic integration may be intended when the compound semiconductor waveguide (optical device 10h) illustrated in FIG. 11 is used as a waveguide for coupling between the integrated circuit configuration components.

### INDUSTRIAL APPLICABILITY

Embodiments of the present invention may be applied to a technique for examining an optical device in a wafer state.

### REFERENCE SIGNS LIST

1 substrate
2, 2e lower clad layer
3 core layer
4, 4d, 4h waveguide core
5, 5e to 5h upper clad layer
6, 6a to 6c, 6e, 6g, 6h coupling unit
7, 7b laser
8 power monitor
9 optical modulator
10, 10a to 10h optical device
11 90° hybrid coupler
12 photodiode
13 resin
14, 15 integrated circuit configuration component
20, 20d optical fiber
21, 21d, 28 core
22 clad
23 waveguide
24 Si substrate
25, 27 clad layer
26 waveguide layer.

1.-8. (canceled)

9. An optical device comprising:
a first waveguide comprising a core that guides light and a clad surrounding the core, wherein a thickness of the clad between a surface of a coupler of the first waveguide and the core is a thickness with which optical evanescent coupling is capable of being performed with a second waveguide or an optical fiber for monitoring when the second waveguide or the optical fiber is arranged within a range of the surface of the coupler.

10. The optical device according to claim 9, wherein
the thickness of the clad of the first waveguide gradually decreases from a first region toward the coupler, wherein the first region is outside the coupler.

11. The optical device according to claim 10, wherein a first width of a core in the coupler is narrower than a second width of a core in the first region, and wherein the first width of the core is measured in a direction perpendicular to an optical propagation direction of the first waveguide.

12. The optical device according to claim 9, wherein a first width of a core in the coupler is narrower than a second width of a core in a first region outside of the coupler, and wherein the first width of the core is measured in a direction perpendicular to an optical propagation direction of the first waveguide.

13. The optical device according to claim 9, wherein:
the coupler is disposed in a region of the first waveguide connecting integrated circuit configuration components of the optical device or disposed in a region of the first waveguide through which light is input to and output from the integrated circuit configuration components of the optical device.

14. The optical device according to claim 13, wherein:
the integrated circuit configuration components comprise a laser and an optical modulator modulating light from the laser, and
the coupler s provided in a region of the first waveguide connecting the laser with the optical modulator and in a region of the first waveguide outputting light from the optical modulator.

15. The optical device according to claim 13, wherein:
the integrated circuit configuration components include a laser, a 90° hybrid coupler mixing a main signal light with a local light from the laser, and a photodiode receiving output light from the 90° hybrid coupler; and
the coupler is provided in a region of the first waveguide inputting the main signal light to the 90° hybrid coupler, a region of the first waveguide connecting the laser with the 90° hybrid coupler, and a region of the first waveguide connecting the 90° hybrid coupler with the photodiode.

16. An optical coupling method of an optical device, the method comprising:
disposing a second waveguide or an optical fiber for monitoring in a range of a surface of a coupler of a first waveguide with respect to the optical device, wherein the optical device comprises the first waveguide, wherein the first waveguide comprises a first core and a first clad surrounding the first core, and wherein a thickness of the first clad between the surface of the coupler of the first waveguide and the first core is a thickness with which optical evanescent coupling is capable of being performed with the second waveguide or the optical fiber.

17. The optical coupling method according to claim 16, wherein the second waveguide or the optical fiber comprises a second core and a second clad surrounding the second core.

18. The optical coupling method according to claim 17, wherein a thickness of the second clad facing the surface of the coupler is a thickness with which optical evanescent coupling is capable of being performed with the first waveguide, and wherein the second clad is between a surface of the second waveguide or the optical fiber and the second core.

19. The optical coupling method of an optical device according to claim 16, wherein:
the first waveguide is a compound semiconductor waveguide in, the first core and the first clad being formed of a compound semiconductor; and
the second waveguide is a semiconductor waveguide comprising a second core formed of a semiconductor.
